(19) United States
(12) Patent Application Publication
(10) Pub. No.: US 2026/0212581 A1
(43) Pub. Date: Jul. 23, 2026

(54) REAL-TIME NEURAL TEXTURES FOR MATERIAL COMPRESSION

(71) Applicant: Ubisoft Entertainment, Carentoir (FR)

(72) Inventors: Antoine Houdard, Vienne (FR); Georges Nader, Bordeaux (FR)

(21) Appl. No.: 19/035,306

(22) Filed: Jan. 23, 2025

(51) Int. Cl. G06T 15/00; G06T 1/20; G06T 5/20; G06T 5/60; G06T 15/04; G06T 15/06

(52) U.S. Cl. CPC G06T 15/005; G06T 1/20; G06T 5/20; G06T 5/60; G06T 15/04; G06T 15/06; G06T 2207/20081; G06T 2207/20084

(57) ABSTRACT

Systems, methods, and computer-readable media for rendering a texture of an object of a frame. A method may receive a set of compressed neural textures encoding the texture of the object and a neural network for decoding the set of compressed neural textures. The method may store the set of compressed neural textures and the neural network in a memory of the graphics card as a shader function. The method may execute the shader function for the neural network, wherein execution of the shader function comprises decoding the set of compressed neural textures using a decoding technique, filtering the set of compressed neural textures using a filtering technique, wherein the neural network is trained to emulate the decompression and filtering techniques; and lighting the set of compressed neural textures using a lighting shader to reconstruct the physically based rendering texture of the object.

### BACKGROUND

### 1. Field

Embodiments of the present disclosure relate to graphics rendering. More specifically, embodiments of the present disclosure relate to a training procedure for learning a set of neural textures and a corresponding decoder network for efficient graphics card storage and real-time rendering.

### 2. Related Art

In recent years, consumers have had access to improvement computer graphics. For example, many video game consumers now have access to 4K resolution, providing a more realistic and visually beautiful experience. Behind these computer graphic improvements lie significant improvements to software and hardware technology that have given developers tools for providing games at high resolutions. For example, physical-based rendering (PBR) is a technique for modeling properties of 3-dimensional surfaces—like reflectivity, roughness, and light scattering—with 2-dimensional texture maps to render more realistic graphics compared to traditional techniques. The set of texture maps from PBR may then be combined to create a realistic 3D surface at render time.

While PBR provides more realistic graphics, the texture maps produced by PBR often have large memory footprints, and graphics cards have finite memory resources, often making it challenging to store high-resolution textures and render high-resolution textures in real time. As such, embodiments of the disclosure include compression techniques to reduce the amount of memory needed to store textures on graphics cards. Neural textures may have the ability to store textures in a smaller memory space, the neural texture being exported to a graphics card along with a neural network for decoding the neural texture. However, naïve compression of neural features can result to artifacts severely affecting the resulting image quality. For example, if a neural texture is quantized such that it takes up less memory space, the quantized neural texture may result in unacceptable low image quality. On the other hand, if the neural texture is unquantized, the neural texture may require a low resolution to fit in texture memory, again resulting in unacceptable low image quality. As such, there is a need for systems and methods for neural texture compression for real-time rendering. The non-patent publication titled “Real-Time Neural Materials using Block-Compressed Features,” by C. Weinreich, et al., published Feb. 18, 2024 (herein incorporated by reference in its entirety), discloses neural texture compression for real-time rendering.

### SUMMARY

In some aspects, the techniques described herein relate to one or more non-transitory computer-readable media including computer-executable instructions that, when executed by at least one processor, perform a method for graphically rendering a neural texture on an object in a frame by a graphics card, the method including: receiving a set of compressed neural textures encoding the neural texture of the object and a neural network for decoding the set of compressed neural textures; storing the set of compressed neural textures and the neural network in a memory of the graphics card, wherein the neural network is implemented as an inference shader function; receiving a request to render the frame, the request received in real time; executing the inference shader function for the neural network to apply the neural texture to the object to obtain a textured object, wherein execution of the inference shader function includes: decoding the set of compressed neural textures using a decompression technique, wherein the neural network is trained to emulate the decompression technique; and filtering the set of compressed neural textures using a filtering technique, wherein the neural network is trained to emulate the filtering technique; and applying a lighting shader to the textured object to render a lit textured object into the frame.

In some aspects, the techniques described herein relate to one or more non-transitory computer-readable media, wherein the set of compressed neural textures is compressed using BC6 block compression.

In some aspects, the techniques described herein relate to one or more non-transitory computer-readable media, wherein the neural texture is a physically based rendering texture.

In some aspects, the techniques described herein relate to one or more non-transitory computer-readable media, wherein the neural network includes a plurality of weights, each stored as a 16-bit floating point value in GPU memory of the graphics card.

In some aspects, the techniques described herein relate to one or more non-transitory computer-readable media, wherein executing the inference shader function takes fewer than 200 operations.

In some aspects, the techniques described herein relate to one or more non-transitory computer-readable media, wherein filtering the set of compressed neural textures includes performing trilinear filtering on the set of compressed neural textures.

In some aspects, the techniques described herein relate to one or more non-transitory computer-readable media, wherein the neural network is trained using batched stochastic gradient descent and backpropagation.

In some aspects, the techniques described herein relate to a graphics card for graphically rendering a texture of an object in a frame, the graphics card including: a memory storing a set of compressed neural textures associated with the object and a neural network, the neural network implemented as an inference shader function; and one or more non-transitory computer-readable media including computer-executable instructions that, when executed by at least one graphical processing unit, perform a method for graphically rendering the texture of the object in the frame, the method including: receiving a request to render the object in the frame, the request received in real time; executing the inference shader function for the neural network to apply the texture the object and thereby obtain a textured object, wherein execution of the inference shader function includes: decoding the set of compressed neural textures using a decoding technique, wherein the neural network is trained to emulate the decoding technique; and filtering the set of compressed neural textures using a filtering technique, wherein the neural network is trained to emulate the filtering technique; and applying a lighting shader to the textured object to render a lit textured object into the frame.

In some aspects, the techniques described herein relate to a graphics card, wherein the set of compressed neural textures associated with the frame and the neural network are received from an encoder system for generating the set of compressed neural textures and the neural network.

In some aspects, the techniques described herein relate to a graphics card, wherein the encoder system includes: one or more additional non-transitory computer-readable media including additional computer-executable instructions that, when executed by at least one additional processor, perform an additional method for generating the set of compressed neural textures and the neural network, the additional method including: compressing the set of compressed neural textures using block compression; training the neural network to decode the set of compressed neural textures; and exporting the set of compressed neural textures.

In some aspects, the techniques described herein relate to a graphics card, wherein the additional method further includes: generating the set of compressed neural textures using a set of material properties, the set of material properties defining a physically based rendering texture.

In some aspects, the techniques described herein relate to a graphics card, wherein the neural network is trained using backpropagation based on a loss function comparing a reference decoding and filtering of the set of compressed neural textures to an output of the neural network.

In some aspects, the techniques described herein relate to a graphics card, wherein the set of compressed neural textures is compressed using adaptive scalable texture compression.

In some aspects, the techniques described herein relate to a graphics card, wherein the memory includes video random access memory storing at least one GPU buffer, wherein the neural network is stored in the at least one GPU buffer as a plurality of weights.

In some aspects, the techniques described herein relate to an encoding method for generating a neural network for decoding and filtering a set of compressed neural textures associated with a texture of an object of a frame and, the encoding method including: receiving the set of compressed neural textures, wherein the set of compressed neural textures is compressed using block compression; training the neural network to decode the set of compressed neural textures, wherein training includes: inputting the set of compressed neural textures into the neural network to receive an output; comparing a reference decoding of the set of compressed neural textures and the output of the neural network into a loss function; and backpropagating a result of the loss function through the neural network; and exporting the set of compressed neural textures and the neural network to a storage medium; wherein the set of compressed neural textures and the neural network are imported from the storage medium to a graphics card for rendering the frame.

In some aspects, the techniques described herein relate to an encoding method, further including: training the neural network to emulate a filtering technique.

In some aspects, the techniques described herein relate to an encoding method, wherein the graphics card includes: a video random access memory storing the set of compressed neural textures associated with the frame and the neural network trained to emulate the filtering technique; and one or more non-transitory computer-readable media including computer-executable instructions that, when executed by at least one graphical processing unit, perform a rendering method for graphically rendering the texture of the object in the frame, the rendering method including: receiving a request to render the frame, the request received in real time; and executing an inference shader function for the neural network, wherein execution of the inference shader function includes: decompressing the set of compressed neural textures using a decompression technique, wherein the neural network is trained to emulate the decompression technique; filtering the set of compressed neural textures using the filtering technique.

In some aspects, the techniques described herein relate to an encoding method, wherein the rendering method further includes: executing one or more shader functions on the frame, the one or more shader functions including at least one of a vertex shader, a geometry shader, a compute shader, a tessellation control shader, a tessellation evaluation shader, or ray tracing shader.

In some aspects, the techniques described herein relate to an encoding method, wherein the neural network is implemented on the graphics card as a fragment shader.

In some aspects, the techniques described herein relate to an encoding method, wherein the neural network is trained using batched stochastic gradient descent.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWING FIGURES

Embodiments of the present disclosure are described in detail below with reference to the attached drawing figures, wherein:

FIG. 1 depicts an exemplary hardware system in accordance with embodiments of the invention;

FIG. 2 depicts an exemplary graphics system in accordance with embodiments of the invention;

FIG. 3 depicts an exemplary encoder system in accordance with embodiments of the invention;

FIG. 4 depicts an exemplary flowchart for illustrating the operation of a method in accordance with embodiments of the invention;

FIG. 5 depicts an exemplary rendering system in accordance with embodiments of the invention; and

FIG. 6 depicts an exemplary flowchart for illustrating the operation of a method in accordance with embodiments of the invention.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized and changes can be made without departing from the scope of the present disclosure. The following detailed description is, therefore, not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments but is not necessarily included. Thus, the technology can include a variety of combinations and/or integrations of the embodiments described herein.

Aspects of the disclosure relate to encoder systems and decoder systems for graphical image rendering. The encoder system comprises an encoder module and a compression module. The encoder system utilizes machine learning to train a neural texture set and a corresponding decoder neural network for the neural texture set. Each set of neural textures may have its own corresponding decoder neural network. The neural network may be trained to estimate a filter such as a trilinear filter. The neural texture set is compressed into a block compression (BC) format, such as one of BC1 through BC7. For example, the compression module may compress the neural texture set into a BC6 compression format when the neural texture set is to be exported to a graphics card natively implementing BC6 decompression.

The neural texture set and the decoder neural network can subsequently be exported to a GPU and stored in the memory of a graphics card, such as the video random access memory (VRAM). The textures can be stored as any other texture, and the neural network stored as a shader in an appropriate shader language supported by the GPU, with the weights of the neural network stored as 16-bit floating point values. After receiving a request to render an object associated with the neural texture set, the graphical processing unit (GPU) of the graphics card may access, in real time, the neural texture set. The neural texture may then be applied (alone or in addition to other textures) to a polygon mesh representing the object to be rendered. During a shading step of the rendering pipeline, the GPU may then apply the shader implementing the decoder neural network to the neural texture, thereby reconstructing the original (uncompressed) texture to be applied to the object.

### Operational Environment

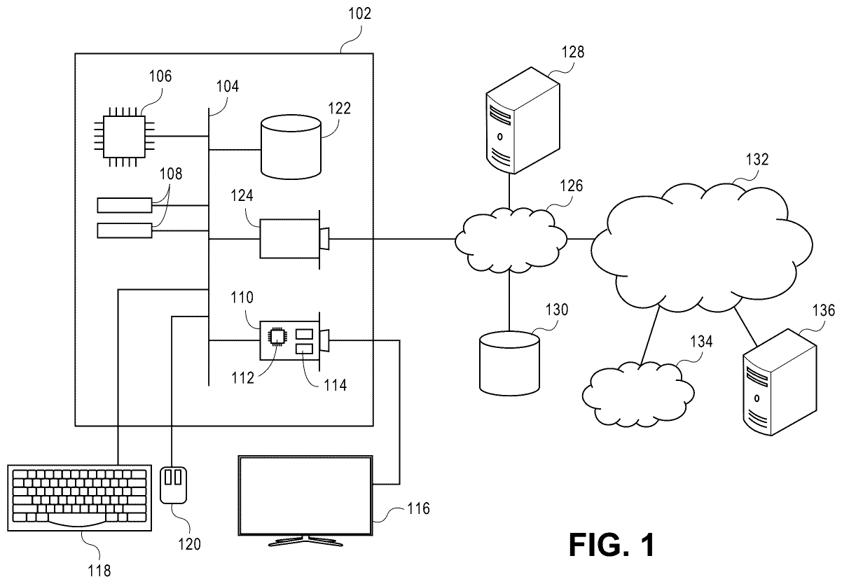

FIG. 1 illustrates an exemplary hardware platform relating to some embodiments of the present disclosure. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple buses, or components may communicate with each other directly. Connected to system bus 104 is CPU 106, also known as a central processing unit or a processor. Also attached to system bus 104 are one or more random-access memory modules 108, also known as RAM. Also attached to system bus 104 is graphics card 110. In some embodiments, graphics card 110 may not be a physically separate card but rather may be integrated into the motherboard or the CPU 106. In some embodiments, graphics card 110 has a separate graphics-processing unit (GPU) 112, which can be used for graphics processing or for general-purpose computing (GPGPU). Also on graphics card 110 is GPU memory 114, sometimes referred to as VRAM. Connected (directly or indirectly) to graphics card 110 is display 116 for user interaction. In some embodiments, no display is present, while in others, it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removably attached.

Such non-transitory computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-executable instructions, data structures, program modules, and other data representations.

Finally, NIC 124, also referred to as a network interface card, is also attached to system bus 104 and allows computer 102 to communicate over a network such as local network 126. NIC 124 can be any form of network interface known in the art, such as Ethernet, ATM, fiber, Bluetooth®, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

### System Architecture

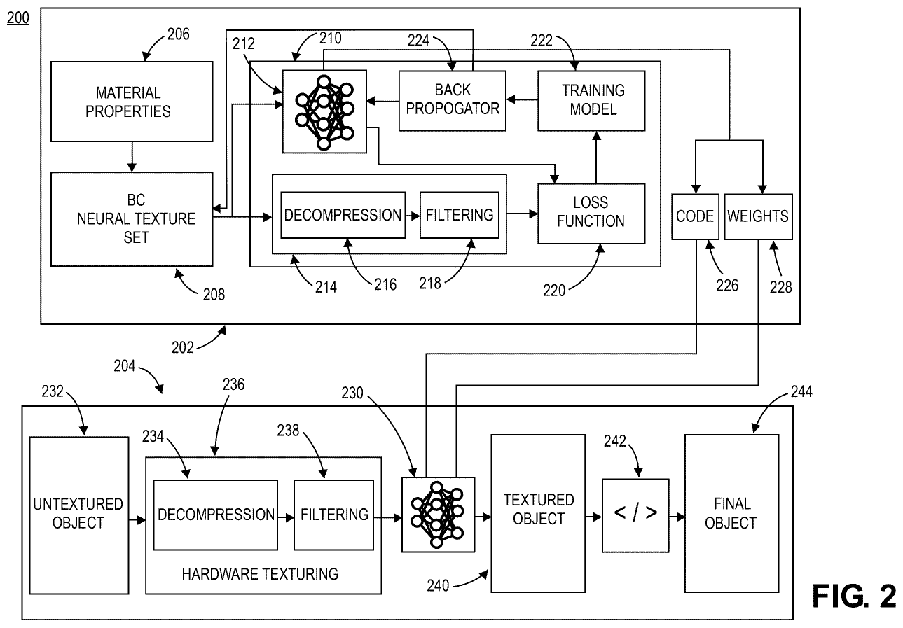

FIG. 2 depicts an example of graphics system 200 in accordance with embodiments of the invention. Broadly, graphics system 200 renders a frame in real time using neural textures and hardware compression techniques. Neural textures encode learned latent features representing the material properties of a texture (described below) and, when decoded by a neural network, regenerate the original texture. Each neural texture may be able to encode a plurality of layers of a texture, where each layer represents a material property. As such, by encoding material properties as neural textures, less memory space may be required to store the neural textures compared to the layers of the original texture, which may be advantageous in an environment with limited memory space, such as a graphics card.

Graphics system 200 includes encoder system 202 and rendering system 204. Encoder system 202 encodes a given texture set as a BC neural texture set, trains a neural network to decode the BC neural texture set, and exports the BC neural texture set and the corresponding neural network to rendering system 204 for rendering. Encoder system 202 may be executed on any computer system now known or later developed, including, but not limited to, those discussed above with respect to FIG. 1.

In some embodiments, encoder system 202 begins with material properties 206, which may include a plurality of texture layers for physical-based rendering of an object made of a particular material. For example, material properties 206 may information needed for generating a base layer, a roughness layer, a metallic properties layer, and a transparency layer. During rendering, once the layers of material properties 206 are overlayed on top of each other on an object, the layers of material properties 206 form the physics texture of the object.

Encoder system 202 encodes material properties 206 as BC neural texture set 208. In some embodiments, BC neural texture set 208 is block compressed using a compression format native to a predetermined rendering system, such as rendering system 204. For example, if BC6 is the native compression format for rendering system 204, rendering system 204 is computationally optimized for BC6 compression. Compression of material properties 206 in a format native to a predetermined rendering system is advantageous, as the rendering system may require fewer computation cycles to decompress material properties 206 relative to textures stored in non-native formats. Furthermore, by using a compression format, such as BC6, that encodes floating-point values, compression can be achieved without reducing the resolution of the texture or quantizing the floating-point values, either of which can reduce perceived texture quality.

BC neural texture set 208 may be generated using any technique or combination of techniques now known or later developed for generating neural texture sets, including, but not limited to, batched stochastic gradient descent, backpropagation, reinforcement learning, decision trees, support vector machines, k-means clustering, principal component analysis, gradient boosting, convolutional neural networks, and recurrent neural networks. For example, BC neural texture set 208 may be trained in a substantially similar manner to neural network 212 discussed below.

In some embodiments, BC neural texture set 208 is provided to neural network training system 210. Neural network 212 may be trained to receive BC neural texture set 208 as an input and perform (or simulate) decoding of BC neural texture set 208, thereby reconstructing material properties 206. However, unless carefully implemented, BC6 decompression (as implemented by hardware) may not be trainable using a neural network. As such, embodiments disclosed herein may use differentiable BC6 decompression to simulate BC6 hardware decompression for each pixel within a block.

When used in two-partition mode, a BC6 block stores two sets of quantized endpoints, the pixel indices, and a partition ID. The decompression operation uses this data to recover back the original information by mixing the endpoints proportionally with the index values. In particular, conventional BC6 decoding relies on a typecast operation to reinterpret an integer value between −31,743 and 31,743 as an IEEE half-precision value. This type-cast is non-linear, and thus, the decompression operation as a whole is non-differentiable, meaning that back-propagation cannot be used to train a neural network to simulate the conventional BC6 decompression operation. Instead, decompression module 216 implements a novel differentiable BC6 decompression operation, where the typecast operation above is replaced by the equations

$$w ( y ) = {2}^{h ( y ) - 14} ( \frac{y}{1024} - h ( y ) ) ,$$

where y is the integer value and h(y)=max (└y−1/1024┘−1, 0). In this way, the decompression operation is almost-everywhere differentiable, and back-propagator 224 can thus be used to train neural network 212 to simulate BC6 decompression.

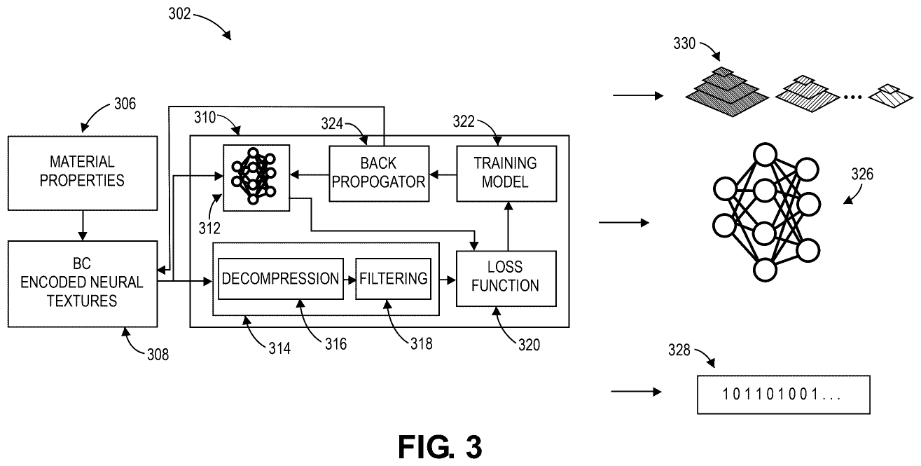

As discussed below with respect to neural network 212, neural network 212 may be trained to emulate filtering and block decompression native to the hardware on which it is to be run, such as rendering system 204. By emulating filtering and decompression, neural network 212 may filter and decompress BC neural texture set 208 with more computational efficiency than if BC neural texture set 208 was filtered and decompressed in the conventional rendering pipeline. The advantages of emulating filtering and decompression are discussed further below with regard to FIG. 3.

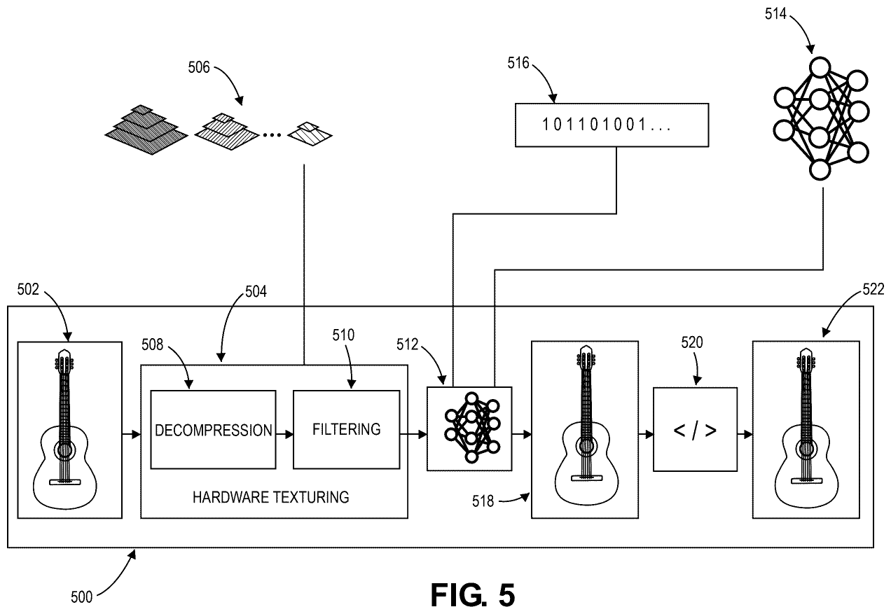

In some embodiments, the size of neural network 212 may be restricted to, for example, having only a single hidden layer limited to 16 or 32 neurons (e.g., one hidden layer of dimension 16 or 32). Unlike conventional neural networks, where increases in performance are driven by increasing the number of parameters (and therefore) the number of neurons, embodiments of the disclosure advantageously constrain the number of neurons such that the corresponding decoder neural network can be implemented efficiently as a shader. The advantages of reducing the size of neural network 212 are discussed further below with regard to FIGS. 3 and 5.

In some embodiments, neural network 212 is a multilayer perceptron. By implementing neural network 212 as a multilayer perceptron, neural network 212 may be differentiable, allowing the multilayer perceptron to be trained using backpropagation due to the ability to calculate gradients and adjust the weights of neural network 212 accordingly. It is contemplated herein that neural network 212 may be any type of neural network now known or later developed, including, but not limited to, a convolutional neural network (CNN), a recurrent neural network (RNN), a long short-term memory (LSTM), a gated recurrent unit (GRU), a generative adversarial network (GAN), a radial basis function network (RBFN), an autoencoder, or a transformer.

Neural network 212 and/or BC neural texture set 208 may be trained by neural network training system 210, including training model 222 in tandem with back-propagator 224 (described below). In some embodiments, training model 222 is a batched stochastic gradient descent (BSGD) model, the advantages of which are discussed below with regard to FIG. 3. A BSGD model may update the weights of neural network 212 based on the output of neural network 212 given a small, randomly selected subset of training samples (a batch) rather than the entire dataset or a single sample. It is contemplated, however, that training model 222 may be any type of machine learning known or later developed, including (but not limited to) unsupervised learning techniques, stochastic gradient descent, reinforcement learning, decision trees, support vector machines, k-means clustering, principal component analysis, gradient boosting, convolutional neural networks, and recurrent neural networks.

Neural network 212 may be trained using back-propagator 224, where back-propagator 224 retrains neural network 212 by causing the weights of neural network 212 to update given the error calculated for the output of neural network 212 for a given training iteration compared to a reference decompression (and, as discussed below filtering) implementation. As such, the output of neural network 212 may be input into loss function 220 for comparison with that of the reference implementation, where loss function 220 is any function for calculating the difference between two texture sets, including, but not limited to, a mean-squared-error function. Additionally, BC neural texture set 208 may be trained using back-propagator 224, where the values of BC neural texture set 208 are updated given the error calculated for the output of BC neural texture set 208 for a given training iteration.

In order to calculate the value of the loss function for a given iteration of neural network 212 and the actual output of neural network 212, BC neural texture set 208 may be decompressed and filtered using reference decoder 214 prior to being provided to loss function 220. Generally, reference decoder 214 accesses texels from BC neural texture set 208 at one or more sample points for determining an error value in the output of neural network 212 during a given training iteration. Additionally, in some embodiments, if neural network 212 emulates trilinear filtering, filtering module 218 may perform trilinear filtering on BC neural texture set 208.

When loss function 220 is minimized (or otherwise reduced to an acceptable level), the training of neural network 212 may be terminated, and neural network code 226 (corresponding to neural network 212) and neural network weights 228 (corresponding to the weights of neural network 212) may be exported to rendering system 204. Accordingly, rendering system 204 may store neural network code 226 and neural network weights 228 in inference shader 230. As mentioned above, by storing and executing the neural network in a shader function, the neural network may be executed more efficiently than conventional decoder and filtering functions being executed in the rendering pipeline due to hardware optimization of shader functions and the small size of shader functions.

Broadly, rendering system 204 renders a frame including objects with textures encoded by BC neural texture set 208. As such, given the computation and memory efficiencies of BBC neural texture set 208 along with neural network 212, rendering system 204 may render a frame including textures encoded by BC neural texture set 208 more quickly (or at a similar speed but at a higher resolution) compared to conventional textures and neural textures compressed by other means. Rendering system 204 receives a request for a frame, accesses a set of BC neural textures for the frame, performs decompression and filtering on the BC neural texture set, decodes the resulting neural texture set using a shader, and renders the frame. Rendering system 204 may execute within the GPU of a graphics card, such as a graphics card with a single instruction, multiple data (SIMD) architecture. By emulating the conventional texture decoding and shading processes using a neural network, rendering system 204 may render textures more quickly and/or at a higher resolution than by using a conventional decoder and filtering operation due to the efficiencies of applying a limited-size, shader-implemented neural network.

In some embodiments, during the process of rendering a frame including a PBR object, the mesh of the frame is first rendered conventionally, giving an untextured frame including untextured object 232. To texture untextured object 232 appropriately, hardware texturing 236 is implemented. Generally, hardware texturing 236 includes the processes through which rendering system 204 applies a set of textures to a given object, including mapping the points of the object to points of the texture.

In some embodiments, hardware texturing 236 includes decompression 234 and filtering 238. Broadly, decompression 234 and filtering 238 are native to rendering system 204 such that hardware texturing 236 may be optimized to perform decompression 234 and filtering 238, meaning hardware texturing 236 can execute said techniques more efficiently than other non-native techniques. Upon accessing the appropriate texture set from texture memory, decompression 234 decompresses the texture set. Additionally, the texture set undergoes filtering 238 (such as trilinear filtering) to appropriately map the texture to the position of the object within the frame. Decompression 234 and filtering 238 may perform decompression and filtering techniques substantially similar to those emulated by neural network 212, as discussed above.

After hardware texturing, the BC neural texture set is applied to the object is decoded using inference shader 230, which executes neural network code 226 and neural network weights 228 of neural network 212 as applied to BC neural texture set 208. Broadly, neural network code 226 and neural network weights 228 are stored in and executed by inference shader 230. Inference shader 230 may be any type of shader, including a fragment shader. In some embodiments, the memory space of inference shader 230 may be limited, making the small size of neural network 212 advantageous. For example, neural networks for quantized or other compressed neural textures may be too large to be stored and executed within a shader function. Thus, other neural textures besides BC natural textures may be unable to take advantage of the optimization of shader functions on certain hardware platforms. For example, inference shader 230 may be written in a language supported by rendering system 204, allowing rendering system 204 to execute inference shader 230 without translating inference shader 230 into a language supported by rendering system 204, improving time efficiency relative to other techniques of executing a neural network within rendering system 204.

Decoding BC neural texture set 208 using inference shader 230 results in textured object 240 overlayed with the reconstructed PBR texture. This PBR texture does not represent the visual appearance of the object but rather the material properties—such as roughness, metallic properties, ambient occlusion, transparency, specularity, and emission—that inform how light interacts with the material. In some embodiments, additional shaders, such as lighting shader 242, are applied to textured object 240 overlayed with the reconstructed PBR texture to generate the final textured object. Lighting shader 242 may be implemented as a plurality of shaders, including but not limited to, vertex shaders, fragment shaders, geometry shaders, compute shaders, tessellation control shaders, tessellation evaluation shaders, and ray tracing shaders. Lighting shader 242 may output final object 244, where final object 244 is a part of the frame requested.

### Encoder System

FIG. 3 depicts an example of an encoder system 302 in accordance with embodiments of the invention. Broadly, encoder system 302, generally related to encoder system 202, trains a decoder neural network using machine learning to approximate a conventional decoder and trilinear filter for a given BC6 neural texture set. In some embodiments, as described above, encoder system 302 takes, as input, material properties 306, generally related to material properties 206 described above, which can be used to generate a PBR texture set for the material. For example, material properties 306 may include base color (albedo), normal details (normal maps), roughness, metallic properties, ambient occlusion, transparency (alpha), height information (displacement maps), specularity, emission (self-illumination), and detail or variation (grunge or wear maps).

Encoder system 302 encodes material properties 306 as BC neural texture set 308, generally related to BC neural texture set 208 described above. In some embodiments, BC neural texture set 308 is compressed using a compression format native to a predetermined rendering system, such as rendering system 204. A compression format that is native to a rendering system is defined as a format that is computationally optimized by the rendering system compared to other formats. For example, if BC6 is the native compression format for rendering system 204, rendering system 204 is computationally optimized for BC6 compression. Performing compression of material properties 306 in a format native to a predetermined rendering system is advantageous, as the rendering system may require fewer computation cycles to decompress material properties 306 relative to textures stored in non-native formats.

In some embodiments, block compression is used to compress BC neural texture set 308, where block compression is a data compression technique that divides data into fixed-size blocks and reduces the size of each block independently. For example, BC6 compression divides an image into 4×4 pixel blocks, compressing each block individually through interpolation and endpoint encoding. Endpoint encoding and interpolation involves storing two endpoint color values, with the position of the remaining pixel values being represented by an index value along the interpolated gradient between the two endpoint color values. Advantageously, each block encodes red-green-blue (RGB) channel data using 16-bit float values, allowing for a wider range of values to be stored relative to other block compression formats. It should be understood, however, that, for PBR textures, the channel values may encode non-RGB information. In some embodiments, BC neural texture set 308 is compressed in BC6 format; however, it is contemplated that other compression formats may be used, including, but not limited to, BC1 (DXT1), BC2 (DXT3), BC3 (DXT5), BC4, BC5, BC6H, BC7, and adaptive scalable texture compression (ASTC). In some embodiments, BC neural texture set 308 is differentially encoded, meaning that BC neural texture set 308 stores the differences in pixel values rather than the absolute location of the pixel values in a given block.

BC neural texture set 308 may be generated using any technique or combination of techniques now known or later developed for generating neural texture sets, including, but not limited to, batched stochastic gradient descent, backpropagation, reinforcement learning, decision trees, support vector machines, k-means clustering, principal component analysis, gradient boosting, convolutional neural networks, and recurrent neural network. BC neural texture set 308 may be mipmapped to include a plurality of levels of neural textures. Mipmapping is a technique that creates and stores a plurality of scaled-down levels of a texture to represent differences in viewing textures from various distances or angles. As such, each point (u,v) is accessible at every mipmap level of the neural texture. For example, as depicted in FIG. 3, BC neural texture set 308 may include 4 levels, each level being scaled down from the previous level. In such embodiments, each point is represented as (u,v,s), where (u,v) is the coordinate location of the point and s is the scale, where the scale is the level of mipmap.

In some embodiments, BC neural texture set 308 is provided to neural network training system 310, generally related to neural network training system 210 described above, for training. As mentioned above, neural network 312 may be trained by neural network training system 310 to receive BC neural texture set 308 as an input and simulate decoding of BC neural texture set 308, thereby reconstructing material properties 306. Broadly, neural network 312 is a collection of neurons arranged in an input layer, one or more hidden layers, and an output layer. Each neuron receives one or more inputs, each having a weight, and generates an output based on the received weighted inputs. The output of the neuron may then be used by another neuron in combination with a weight. In some embodiments, neural network 312 includes less than 32 neurons. For example, neural network 312 may include 1 hidden layer of 16 neurons.

Unlike conventional neural networks, where increases in performance are driven by increasing the number of parameters (and therefore) the number of neurons, embodiments of the disclosure advantageously constrain the number of neurons such that the corresponding decoder neural network can be implemented efficiently as a shader. For example, shader instruction slots may be limited to 512, 4096, or 65536 instructions for a given GPU. Additionally, for performance reasons, it may be desirable to keep the total size of all shaders (or all shaders for a set of objects being rendered in a given scene) below the shader cache size (for example, 128 MB). These constraints make conventional approaches to neural networks impractical, because even small conventional neural networks include millions of parameters, requiring millions of operations and gigabytes of working set storage size. By contrast, for example, limiting neural network size to 1 hidden layer of 16 neurons, as disclosed above, reduces the total instructions required to approximately 200 operations, making both storage and execution as a shader practical.

As mentioned above, neural network 312 is trained to decode and filter BC neural texture set 308. During the training process, neural network 312 receives BC neural texture set 308. Accordingly, in some embodiments, neural network 312 is trained using the pixels of BC neural texture set 308, where a pixel is located at (u, v, s), where (u,v) is the coordinate of the pixel and s is the scale. By training neural network 312 with pixels at all scales, neural network 312 may decode all mipmap levels in a real-time rendering environment.

In some embodiments, neural network 312 is a multilayer perceptron. By implementing neural network 312 as a multilayer perceptron, neural network 312 may be differentiable, allowing the multilayer perceptron to be trained using backpropagation due to the ability of an MLP to calculate gradients and adjust the weights of neural network 312 accordingly. It is contemplated herein that neural network 212 may be any type of neural network now known or later developed, including, but not limited to, a convolutional neural network (CNN), a recurrent neural network (RNN), a long short-term memory (LSTM), a gated recurrent unit (GRU), a generative adversarial network (GAN), a radial basis function network (RBFN), an autoencoder, or a transformer.

In some embodiments, neural network 312 is trained to emulate native decompression and filtering techniques of the hardware rendering BC neural texture set 308, such as rendering system 204 and rendering system 500 (described below). Emulating the native decompression and filtering techniques of the rendering system is advantageous over conventional decompression and filtering performed on texture sets and neural texture sets because fewer computational cycles are needed to decompress and filter. For example, to filter a texel using trilinear filtering, 8 additional texels need to be accessed. Accordingly, if trilinear filtering is performed on the texels of a texture after decoding by the neural network, a substantially greater number of computation cycles are required due to the need to fetch all eight adjacent texels.

Neural network 312 may be trained by training model 322 in tandem with backpropagation (described below). In some embodiments, training model 322 is a batched stochastic gradient descent (BSGD) model. A BSGD model may update the weights of neural network 312 based on the output of neural network 312 given a small, randomly selected subset of training samples (a batch) rather than the entire dataset or a single sample. For example, BSGD may be used to train neural network 312, where points (u, v, s) are sampled uniformly, and the mipmap levels of BC neural texture set 308 are sampled according to the importance of each mipmap level (e.g., the likelihood that a mipmap level will be rendered). Using a BSGD model may be advantageous, as it may cause neural network 312 to converge to an optimal output of neural network 312 more quickly than other machine learning techniques due to the smoother, more gradual gradient updates caused by batch sampling. It is contemplated, however, that training model 322 may be any type of machine learning known or later developed, including (but not limited to) unsupervised learning techniques, stochastic gradient descent, reinforcement learning, decision trees, support vector machines, k-means clustering, principal component analysis, gradient boosting, convolutional neural networks, and recurrent neural networks.

Neural network 312 may be trained using back-propagator 324 to perform backpropagation. Generally, backpropagation is the process of retraining a neural network (such as neural network 312) by updating the weights of the neural network given the error calculated for an output of the neural network for a given training iteration compared to the output of a reference function to be emulated. As such, the output of neural network 312 may be input into loss function 320 for comparison with a reference decoder 314, where loss function 320 is any function for calculating the difference between two (filtered) texture sets, including, but not limited to, a mean squared error function. For example, loss function 320 may sum the squares of the differences in the channel values for each individual texel at each scale between the output of neural network 312 and the expected texel values. Accordingly, the output of loss function 320 may be used by training model 322 through back-propagator 324 to retrain neural network 312 by updating the weights of neural network 312. Additionally, BC neural texture set 308 may be trained using back-propagator 324, where the values of BC neural texture set 308 are updated given the error calculated for the output of BC neural texture set 308 for a given training iteration. For example, the output of loss function 320 may be used by training model 322 through back-propagator 324 to retrain BC neural texture set 308 by recalculating the values of BC neural texture set 308.

In order to calculate the difference between the expected output of neural network 312 and the actual output of neural network 312, BC neural texture set 308 may be decompressed and filtered using reference decoder 314 prior to being provided to loss function 320. Generally, reference decoder 314 transforms BC neural texture set 308 into reference (e.g., expected) texel values for determining errors in the output of neural network 312 during training. As such, decompression module 316 of reference decoder 314 may decompress neural texture set 304 from block compression format, such as BC6 format. Decompression module 316 may perform a number of functions to decompress BC neural texture set 308, including, but not limited to, bit extraction, inverse quantization, and interpolation. Additionally, neural network 312, as mentioned above, may emulate the decompression process performed by decompression module 316, and may implement the differentiable BC6 decoding process described above to enable backpropagation of errors.

As mentioned above, neural network 312 may approximate a filter such that neural network 312 performs reconstruction of material properties 306 in a filtered form. As such, in some embodiments, before providing BC neural texture set 308 to loss function 320 to determine error, filtering module 318 of reference decoder 314 may filter BC neural texture set 308. Generally, filtering module 318 performs the same filtering process that neural network 312 emulates, as described above. For example, if neural network 312 emulates trilinear filtering, filtering module 318 may perform trilinear filtering on BC neural texture set 308. It is noted herein, however, that filtering module 318 may perform a number of filtering techniques, including, but not limited to, nearest-neighbor filtering, bilinear filtering, trilinear filtering, anisotropic filtering, mipmapping, and Gaussian filtering.

When loss function 320 is minimized (or otherwise reduced to an acceptable level) such that the error between the output of neural network 312 and the expected texture set is minimized (after any number of training iterations), the training of neural network 312 may be terminated. Upon termination of the training of neural network 312, hardware-formatted BC neural texture set 330, hardware-formatted neural network 326, and hardware-formatted neural network weights 328 are exported. At this point, hardware-formatted BC neural texture set 330 (corresponding to BC neural texture set 308), hardware-formatted neural network 326 (corresponding to shader code for implementing neural network 312), and hardware-formatted neural network weights 328 (corresponding to the weights of neural network 312) may be exported in formats compatible with the systems in which they are being exported to, such as rendering system 204 and rendering system 500. For example, the weights of neural network 312 may be stored as 1 kb of 16-bit float values for storing in at least one GPU buffer of a graphics card. For another example, hardware-formatted BC neural texture set 330 may be exported as a mipmapped set of neural textures.

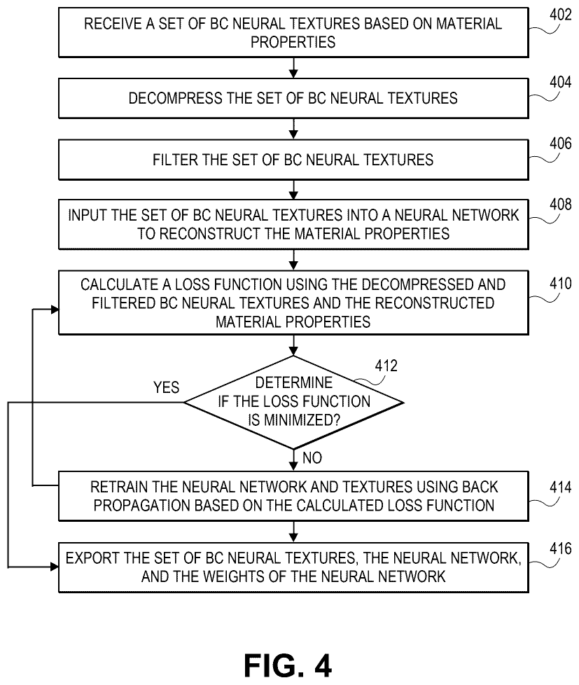

FIG. 4 depicts an exemplary flowchart for illustrating the operation of a method in accordance with embodiments of the invention, generally referred to as method 400. Method 400 is a method for training a neural network for decoding a given BC neural texture set. In some embodiments, method 400 may be executed by encoder system 302, as depicted in FIG. 3. In step 402, a set of BC neural textures based on a set of material properties is received. For example, a set of neural textures encoded in BC6 may be received, where the set of neural textures encodes a plurality of material properties, including roughness, transparency, and metallic properties.

In step 404, the set of BC neural textures is decompressed. For the purposes of method 400, decompressing the BC neural textures refers to accessing a set of appropriate texels corresponding to the stochastic batch for a given training iteration. As mentioned above, the set of BC neural textures may be decompressed in order to serve as a set of reference texel values for calculating the loss function relative to the training state of the corresponding neural network. For example, if the BC neural texture set is compressed in BC6 format, the BC neural texture set may be decompressed from BC6 format using a conventional BC6 decoding process or a differentiable BC6 decoding process. As such, the BC neural texture set may be decompressed in the same format that the neural network is being trained to emulate.

In step 406, the set of BC neural textures is filtered appropriately. In some embodiments, the neural network being trained to decode the BC neural texture set may be trained to emulate filtering, such as trilinear filtering. Accordingly, the set of BC neural textures may be filtered in order to produce the expected pixel values to use in calculating the loss function with regard to the output of the neural network during training. For example, if the neural network is trained to emulate trilinear filtering, trilinear filtering may be performed on the texels at step 406.

In step 408, the set of BC neural textures is provided to a neural network in order to reconstruct the material properties. As discussed above, the neural network may map the values of the BC neural textures to the values of the material properties they are encoded to represent. As such, by inputting the BC neural textures into the neural network, the neural network may output a reconstructed version of the material properties at particular texel values and scales. In step 410, a loss function is calculated using the reference texel values and texel values computed by the neural network. As discussed above, the loss function may compare the similarity between the expected output in the form of the decompressed and filtered BC neural textures and the current output of the neural network. As described above, batched stochastic gradient descent may be used for the training process in some embodiments. In such embodiments, the gradient is computed on a batch B of random values of (u, v, s). The output of the loss function signifies how different the output of the neural network is from the expected outcome, thereby indicating whether more training needs to occur in order to minimize the loss function and improve the neural network.

In step 412, it is determined whether the loss function is minimized. If the loss function is not minimized, the method proceeds to step 414. In step 414, the neural network and the BC neural textures are trained using backpropagation based on the calculated loss function. For example, as discussed above, the calculated loss function may be fed back into the neural network, and the neural network may adjust the weights given to the neural network based on the calculated loss function. As such, the neural network may output a more precise texture set based on the updated weights. For another example, the values of the BC neural textures may be updated to more precisely construct the expected texture set when decoded with the neural network. Accordingly, after step 414, the method may proceed back to step 410, in which the loss function is calculated using the reconstructed material properties outputted by the neural network and the expected texture set.

Returning to step 412, if it is determined that the loss function is minimized or adequately small, method 400 may proceed to step 416, in which the set of BC neural textures, the neural network for decoding the set of BC neural textures, and the weights of the neural network are exported. In some embodiments, the neural network, weights, and BC neural textures may be exported to a rendering system, such as a graphics card, where they are stored in the memory of the rendering system for use in real-time rendering, as discussed below with regard to FIG. 5.

### Decoder System

FIG. 5 depicts an example of a rendering system 500, in accordance with embodiments of the invention. Broadly, rendering system 500, generally related to rendering system 204 depicted in FIG. 2, receives a request for a frame including a PBR object, textures and filters a wire mesh for the object, performs decompression and filtering on a BC neural texture set using a shader, and applies lighting shaders to render the final object in the frame. Rendering system 500 may execute within the GPU of a graphics card, such as a graphics card with a single instruction, multiple data (SIMD) architecture. By rendering a texture from neural textures decoded by a neural network emulating native filtering and decompression techniques, rendering system 500 may render textures more quickly and/or at a higher resolution than conventional BC textures.

In some embodiments, a request for a frame is received, and the wire mesh for the frame is rendered, including untextured object 502, generally relating to untextured object 232 depicted in FIG. 2. Initially, hardware texturing 504 is performed on untextured object 232, generally relating to hardware texturing 236 depicted in FIG. 2. Generally, hardware texturing 504 includes the processes through which rendering system 500 applies a texture to a given object. As such, hardware texturing 504 receives one or more texture sets to be applied to untextured object 502.

In some embodiments, hardware texturing 504 includes decompression 508 and filtering 510, generally relating to decompression 234 and filtering 238 depicted in FIG. 2. Broadly, decompression 508 and filtering 510 are native to rendering system 500 such that hardware texturing 504 may be optimized to perform decompression 508 (such as BC6 decompression) and filtering 510 (such as trilinear filtering), meaning hardware texturing 504 can execute said techniques more efficiently than other non-native techniques. Generally, decompression 508 performs a substantially similar function to decompression module 316 described above with regard to FIG. 3. In a similar manner to filtering module 318 described above with regard to FIG. 3, filtering 510 may perform a variety of filtering techniques, including trilinear filtering, bilinear filtering, and temporal filtering.

After hardware filtering, the BC6 neural texture set is decoded and filtered using inference shader 512, generally relating to inference shader 230 depicted in FIG. 2, which executes neural network 514 as applied to BC neural texture set 506. Broadly, neural network 514, along with corresponding network weights 516, is implemented by inference shader 512. Inference shader 512 may be any type of shader, including a fragment shader. Neural network 514 may be a neural network trained in accordance with FIGS. 2 and 3 described above. As such, neural network 514 may decode and filter BC neural texture set 506 to reconstruct the material properties encoded by BC neural texture set 506.

The size of neural network 514 proves advantageous when compared to previously developed neural texture techniques. Namely, by restricting the size of neural network 514, neural network 514 can be executed within a typical shader function for rendering system 500. For example, inference shader 512 may be written in a language supported by rendering system 500, allowing rendering system 500 to execute inference shader 512 without translating inference shader 512 into a language supported by rendering system 500, improving time efficiency relative to other techniques of executing a neural network within rendering system 500.

Decoding, filtering and applying BC neural texture set 506 using inference shader 512 results in textured object 518, generally related to textured object 240, overlayed with the PBR texture. In some embodiments, additional shaders, such as lighting shader 520, generally relating to lighting shader 242 depicted in FIG. 2, are applied to textured object 518 once it has been overlayed with the reconstructed PBR texture. As described above, PBR textures for not represent the visual appearance of the textured object 518 but rather how light interacts with the textured object. Lighting shader 520 generally applies the lighting effects that interact with the PBR textures to determine the final visual appearance of the rendered object. Lighting shader 520 may additionally correct items such as texture stretching, color imbalance, shadow artifacts, blurriness, distortion, perspective errors, and mismatches. Lighting shader 520 may comprise any number of shaders, including but not limited to, vertex shaders, fragment shaders, geometry shaders, compute shaders, tessellation control shaders, tessellation evaluation shaders, and ray tracing shaders. Lighting shader 520 may output final object 522, where final object 522 is a part of the frame requested.

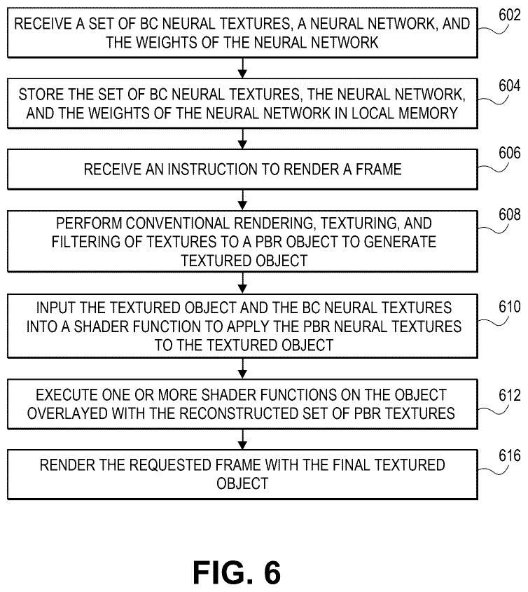

FIG. 6 depicts an exemplary flowchart for illustrating the operation of method 600, in accordance with embodiments of the invention. Method 600 is a method for rendering a frame given a BC neural texture set and a corresponding neural network for decoding the BC neural texture set. In some embodiments, method 600 may be executed by rendering system 500 in FIG. 5. In step 602, a set of BC neural textures, a neural network for decoding said textures, and the weights of the neural network are received. For example, a set of BC neural textures, a neural network for decoding said textures, and the weights of the neural network may be received from an encoder system, such as encoder system 302. For example, as depicted in FIG. 5, a particular PBR object may be a guitar object, the guitar object associated with a particular set of PBR textures encoded in the BC neural texture set, the PBR textures representing the albedo properties of the wood and sound hole, the metallic properties of the strings, pegs, and inlay, and the scattering of the lacquer.

In step 604, the BC neural texture set, the associated neural network, and the neural network weights are stored in memory, such as the memory of a graphics card. For example, the BC neural texture set and the associated neural network may be stored in video random access memory, texture memory, and/or shader memory. In some embodiments, the associated neural network is implemented as a shader function, as described above with regard to FIG. 5. By storing the BC neural texture set in the texture memory of a graphics card, points of the BC neural texture set can be accessed as needed during rendering. In step 606, an instruction is received to render a frame including the PBR object associated with the BC neural texture set. For example, the camera may shift to reveal the guitar, thus indicating that the PBR guitar should be rendered into the scene.

In step 608, conventional rendering of the frame, including rendering, texturing, and filtering of the non-PBR textures for the PBR object, is performed. This results in a flat (unlit), textured object in the scene. For example, the guitar strings may be an appropriate color of grey but will not accurately reflect the shine of metal, and the sound hole will be flat black rather than absorbing light. In step 610, the textured object is overlaid with the BC neural texture implementing the PBR using a shader function with the neural network in order to reconstruct the original set of PBR textures and perform appropriate filtering. Importantly, the PBR textures do not encode visual-channel information. PBR information may be represented by false color for visualization purposes, but the information encoded is how the textured surface should interact with later-applied lighting shaders.

In some embodiments, the BC neural texture set is decompressed by the neural network in the shader function. As discussed above, the neural network may be trained to emulate differentiable BC decoding. As such, the BC neural texture set may be decoded by the neural network as executed by the shader function such that the PBR texture is applied to the textured object. In some embodiments, the BC neural texture set is filtered by the neural network as executed by the shader function. For example, the neural network may be trained to emulate a particular type of filtering, such as trilinear filtering. As such, trilinear filtering may be performed (or emulated) on the BC neural texture set by the neural network. The filtering and decompressing steps of step 608 may be steps optimized by the hardware on which they are implemented, resulting in more computationally efficient rendering compared to non-optimized decompression and filtering steps, resulting in faster rendering and better performance in real-time rendering.

As described above, by decoding the neural texture set in BC format and training the neural network to emulate hardware-native filtering and decompression, the BC neural texture set may require fewer computation cycles and/or better performance relative to other compression and decoding techniques neural textures, including quantized neural textures. Additionally, by storing a neural texture in BC format, the space required for the BC neural texture may be less than that of BC textures and neural textures. Given that graphics cards have limited texture memory and limited computational cycles (especially in a real-time context), BC neural textures and small neural networks for decoding said textures are advantageous.

In step 612, one or more lighting shader functions are executed on the object overlaid with the reconstructed set of PBR textures. Any lighting shader function and any number of additional shader functions may be performed on the object overlaid with the reconstructed set of textures. At this point, the lighting shader will interact with the PBR textures to add glints and shininess to the string while removing any highlights from the sound hold. Furthermore, additional shader functions for smoothing and deblurring may be applied. In step 614, the requested frame with the final textured object is rendered, and may be displayed on a display.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments of the present disclosure, what is claimed as new and desired to be protected by Letters Patent includes the following:

1. One or more non-transitory computer-readable media comprising computer-executable instructions that, when executed by at least one processor, perform a method for graphically rendering a neural texture on an object in a frame by a graphics card, the method comprising:
receiving a set of compressed neural textures encoding the neural texture of the object and a neural network for decoding the set of compressed neural textures;
storing the set of compressed neural textures and the neural network in a memory of the graphics card, wherein the neural network is implemented as an inference shader function;
receiving a request to render the frame, the request received in real time;
executing the inference shader function for the neural network to apply the neural texture to the object to obtain a textured object, wherein execution of the inference shader function comprises:
decompressing the set of compressed neural textures using the neural network to obtain decompressed neural textures; and
filtering the decompressed neural textures using the neural network; and
applying a lighting shader to the textured object to render a lit textured object into the frame.

2. The one or more non-transitory computer-readable media of claim 1,
wherein the set of compressed neural textures is compressed using BC6 block compression.

3. The one or more non-transitory computer-readable media of claim 1, wherein the neural texture is a physically based rendering texture.

4. The one or more non-transitory computer-readable media of claim 1,
wherein the neural network comprises a plurality of weights, each stored as a 16-bit floating point value in GPU memory of the graphics card.

5. The one or more non-transitory computer-readable media of claim 1, wherein the neural network comprises a hidden layer of 32 neurons or less.

6. The one or more non-transitory computer-readable media of claim 1, wherein filtering the set of compressed neural textures comprises performing trilinear filtering on the set of compressed neural textures.

7. The one or more non-transitory computer-readable media of claim 1,
wherein the neural network is trained using batched stochastic gradient descent and backpropagation.

8. A graphics card for graphically rendering a texture of an object in a frame, the graphics card comprising:
a memory storing a set of compressed neural textures associated with the object and a neural network, the neural network implemented as an inference shader function; and
one or more non-transitory computer-readable media comprising computer-executable instructions that, when executed by at least one graphical processing unit, perform a method for graphically rendering the texture of the object in the frame, the method comprising:
receiving a request to render the object in the frame, the request received in real time;
executing the inference shader function for the neural network to apply the texture the object and thereby obtain a textured object, wherein execution of the inference shader function comprises:
decompressing the set of compressed neural textures using the neural network to obtain decompressed neural textures; and
filtering the decompressed neural textures using the neural network; and applying a lighting shader to the textured object to render a lit textured object into the frame.

9. The graphics card of claim 8,
wherein the set of compressed neural textures associated with the frame and the neural network are received from an encoder system for generating the set of compressed neural textures and the neural network.

10. The graphics card of claim 9, wherein the encoder system comprises:
one or more additional non-transitory computer-readable media comprising additional computer-executable instructions that, when executed by at least one additional processor, perform an additional method for generating the set of compressed neural textures and the neural network, the additional method comprising:
compressing the set of compressed neural textures using block compression;
training the neural network to decode the set of compressed neural textures; and
exporting the set of compressed neural textures.

11. The graphics card of claim 10, wherein the additional method further comprises:
generating the set of compressed neural textures using a set of material properties, the set of material properties defining a physically based rendering texture.

12. The graphics card of claim 11, wherein the neural network is trained using backpropagation based on a loss function comparing a reference decoding and filtering of the set of compressed neural textures to an output of the neural network.

13. The graphics card of claim 8,
wherein the set of compressed neural textures is compressed using adaptive scalable texture compression.

14. The graphics card of claim 8,
wherein the memory comprises video random access memory storing at least one GPU buffer, wherein the neural network is stored in the at least one GPU buffer as a plurality of weights.

15. An encoding method for generating a neural network for decoding and filtering a set of compressed neural textures associated with a texture of an object of a frame and, the encoding method comprising:
receiving the set of compressed neural textures, wherein the set of compressed neural textures is compressed using block compression;
training the neural network to decode the set of compressed neural textures, wherein training comprises:
inputting the set of compressed neural textures into the neural network to receive an output;
comparing a reference decoding of the set of compressed neural textures and the output of the neural network into a loss function; and
backpropagating a result of the loss function through the neural network; and
exporting the set of compressed neural textures and the neural network to a storage medium;
wherein the set of compressed neural textures and the neural network are imported from the storage medium to a graphics card for rendering the frame.

16. The encoding method of claim 15, further comprising:
training the neural network to emulate a filtering technique.

17. The encoding method of claim 16, wherein the graphics card comprises:
a video random access memory storing the set of compressed neural textures associated with the frame and the neural network trained to emulate the filtering technique; and
one or more non-transitory computer-readable media comprising computer-executable instructions that, when executed by at least one graphical processing unit, perform a rendering method for graphically rendering the texture of the object in the frame, the rendering method comprising:
receiving a request to render the frame, the request received in real time; and
executing an inference shader function for the neural network, wherein execution of the inference shader function comprises:
decompressing the set of compressed neural textures using the neural network to obtain decompressed neural textures; and
filtering the decompressed neural textures using the neural network.

18. The encoding method of claim 17, wherein the rendering method further comprises:
executing one or more shader functions on the frame, the one or more shader functions comprising at least one of a vertex shader, a geometry shader, a compute shader, a tessellation control shader, a tessellation evaluation shader, or ray tracing shader.

19. The encoding method of claim 17, wherein the neural network is implemented on the graphics card as a fragment shader.

20. The encoding method of claim 15, wherein the neural network is trained using batched stochastic gradient descent.
